(19) United States
(12) Patent Application Publication
(10) Pub. No.: US 2006/0141216 A1
(43) Pub. Date: Jun. 29, 2006

(54) Spliced fabric

(76) Inventors: David R. Hartman, Granville, OH (US); Richard Bustamante JR., New Braunfels, TX (US)

Correspondence Address: OWENS CORNING, 2790 COLUMBUS ROAD, GRANVILLE, OH, 43023, US

(21) Appl. No.: 11/024,078

(22) Filed: Dec. 28, 2004

(51) Int. Cl. B32B 3/00; B32B 7/12; D03D 15/00; B32B 15/04; D03D 25/00; B32B 3/02

(52) U.S. Cl. 428/156; 442/181; 428/157; 428/343

(57) ABSTRACT

A woven reinforcement material includes an elongated body formed from a weave of warp strands and weft strands. The elongated body has a first end section, a second end section and an intermediate section. The intermediate section has a first thickness A and the first and second end sections have a second thickness B where A>B. A method is also provided for securing an elongated body of a woven reinforcement material to a core.

### TECHNICAL FIELD AND INDUSTRIAL APPLICABILITY OF THE INVENTION

This invention relates generally to woven reinforcement materials as well as to a method of securing an elongated body of such material to a core.

### BACKGROUND OF THE INVENTION

Woven reinforcement materials are well known in the art. Such woven fabric was the first type of fibrous glass reinforcement developed for reinforced composite applications. It is used widely because of its high strength characteristics. Today, woven reinforcement material is commonly processed utilizing continuous presses. Such presses allow for continuous movement, “endless” products and dynamic pressing which all serve to increase productivity.

Of course, continuous presses require a continuous supply of woven reinforcement material. In order to provide a continuous supply, sections of woven reinforcement material must be spliced together.

Standard fabric reinforcements of woven, multiaxial knit and assembled combinations are usually butt joined to obtain constant thickness and continuous processes like continuous lamination. Other splicing methods, such as disclosed in U.S. Pat. No. 3,885,071 to Blad et al. and U.S. Pat. No. 3,449,186 to Rano, depend upon the formation of a scarf joint. While various joining methods have been used in the past it is still possible to improve on available joining processes.

Accordingly, the present invention relates to a woven reinforcement material and a method of securing an elongated body of a woven reinforcement material to a core which will allow for improved joining of sections of that material. More specifically, the present invention allows one to optimize consolidation thickness, surface aesthetics and composite structural performance during continuous lamination of rolled goods with inline splicing of individual sections of material by means of a modified overlayer scarf joint. Such a joint transfers process and end use loads over a greater area of work for relieving stresses which have a tendency to break or weaken the joint. The present invention further permits continuous lamination of rolled goods to constant thickness while maintaining both aesthetics and strength. Further, productivity is increased by reducing line downtime for splicing.

### SUMMARY OF THE INVENTION

The woven reinforcement material of the present invention comprises an elongated body formed from a weave of warp strands and weft strands. The elongated body has a first end section, a second end section and an intermediate section. The intermediate section has a first thickness A and the first and second end sections have a second thickness B where
A>B.

Further describing the invention, the intermediate section includes N, a number of, weft strands and the first and second end sections include less than N weft strands. Typically the first and second end sections include N/2 to N/4 weft strands. The intermediate section, the first end section and the second end section all include M warp strands.

More particularly describing the invention, the first end section and the second end section have a length of between about 0.1 to about 1.0 meters. The first and second end sections each have a surface area of between about 100,000 and about 4,000,000 square mm. When end sections of two segments of woven reinforcement material are spliced together they provide a joint with sufficient surface area to relieve stress resulting from process and end use loads.

The elongated body of the woven reinforcement material is constructed from a reinforcing material selected from a group consisting of glass fibers, carbon fibers, aramid fibers, graphite fibers, ceramic fibers, mineral fibers, metal fibers, thermoplastic polymer fibers and mixtures thereof. The individual fibers have a diameter of between about 9.0 to about 27.0 microns. Further the fibers have a length of at least about 25 mm. For some applications the fibers are continuous fibers. The fibers also have between about 200 to about 20,000 tex bundle. The weave of the woven reinforcement material may be selected from a group of different weaves consisting of plain, twill, satin, knit uniaxial, knit biaxial, knit triaxial, knit quadaxial and combinations thereof with mats.

In accordance with yet another aspect of the present invention the first end section includes a first end margin and the second end section includes a second end margin. A first adhesive tape is adhered to the first end margin. A second adhesive tape is adhered to the second end margin. The first and second adhesive tapes may be constructed from a material selected from a group consisting of paper, polyester film, vinyl film, polyvinyl chloride film and mixtures thereof. The adhesive on the tape is an acrylic based resin.

In one possible embodiment, the first adhesive tape extends substantially fully across the first end margin and the second adhesive tape extends substantially fully across the second end margin. A first fastening tape is provided at a first end of the first tape adjacent a first lateral margin of the elongated body. Still further the first fastening tape extends beyond the first lateral margin of the elongated body. Similarly the second fastening tape extends beyond the second lateral margin of the elongated body. Further, a third fastening tape is connected to the first tape between the first and second fastening tapes and extends beyond the first end margin of the elongated body. The fastening tapes may be used to hold the elongated body to a core upon which the elongated body is rolled.

In accordance with yet another aspect of the present invention a method is provided for securing an elongated body of a woven reinforcement material to a core. The method may be broadly described as including the steps of positioning a first end margin of the elongated body onto the face of the core, taping a first corner of the first end margin of the elongated body to the core and taping a second corner of the first end margin of the elongated body to the core so that less than an entire width of the first end margin is taped to the core. The method may further include the taping of an intermediate portion of the end margin to the core between the first and second corners.

More specifically describing the method, the taping of the first end corner includes extending a first strip of tape from the first corner over the first end of the core. Further the taping of the second corner includes extending a second strip of tape from the second corner over the second end of the core. The taping of the intermediate portion includes extending a third strip of tape over the intermediate portion and the face of the core.

The method may also include the step of providing a line of tape over the first end margin of the elongated body from the first corner to the second corner before taping the first corner, the second corner and the intermediate portion to the core. The method further includes the winding of a remainder of the elongated body to the core over the line of tape. In one possible embodiment the method includes the folding of the elongated body over the first end margin and then the winding of a remainder of the elongated body to the core over the line of tape.

In accordance with yet another embodiment and aspect of the present invention the method of securing an elongated body of a woven reinforcement material to a core may be defined as including the steps of: attaching a strip of double-faced adhesive tape to the face of the core from a first point adjacent a first end of the core to a second point adjacent a second end of the core, providing a strip of tape over a first end margin of the elongated body from a first corner thereof to a second corner thereof, and securing the strip of tape on the first end margin of the elongated body to the strip of double-faced adhesive tape attached to the core. This embodiment of the method may include the further step of winding a remainder of the elongated body to the core over the strip of double-faced adhesive tape. Alternatively, this embodiment of the method may include the folding of the elongated body over the first end margin and then winding a remainder of the elongated body to the core over the strip of double-faced adhesive tape.

In the following description there is shown and described several different embodiments of this invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain certain principles of the invention. In the drawings:

FIG. 1 is a fragmentary side elevational view of the woven reinforcement material of the present invention;

FIG. 2 is a top plan view of one end of the woven reinforcement material including end margin tape and fastening tapes;

FIG. 3 is a perspective view illustrating the attachment of the woven reinforcement material of the present invention to a core utilizing the fastening tapes illustrated in FIG. 2;

FIGS. 4a and 4b are end elevational views illustrating two possible ways of winding the woven reinforcement material of the present invention on the core;

FIG. 5 is a perspective view similar to a FIG. 3 but illustrating a second method for securing an end of the woven reinforcement material of the present invention to a core; and

FIGS. 6a and 6b are end elevational views illustrating two possible ways of winding the woven reinforcement material with end tapes as illustrated in FIG. 5 onto a core.

Reference will now be made in detail to the present preferred embodiment of the invention, an example of which is illustrated in the accompanying drawings.

### DETAILED DESCRIPTION AND PREFERRED EMBODIMENTS OF THE INVENTION

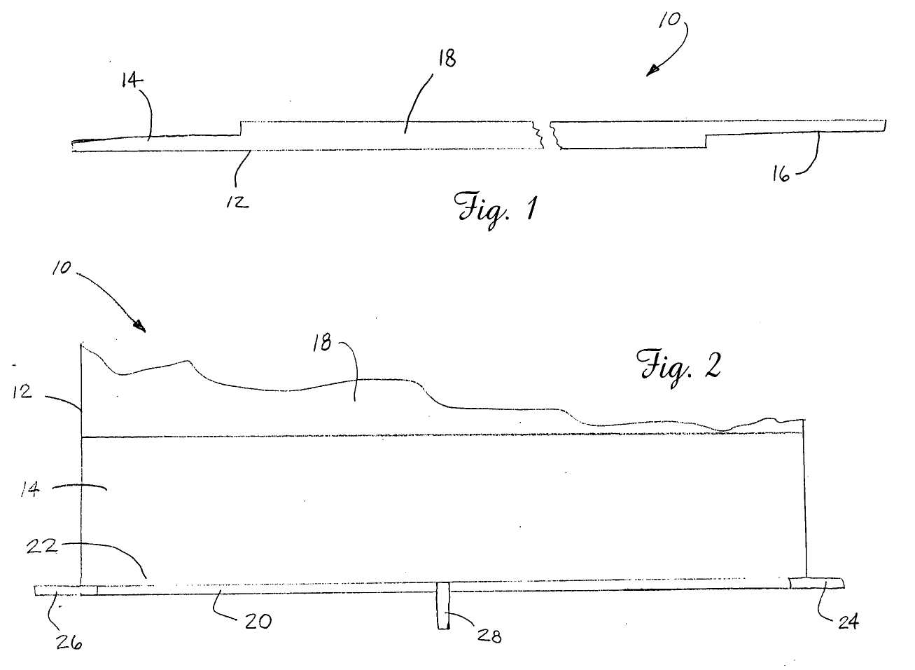

Reference is now made to FIG. 1 illustrating the woven reinforcement material 10 of the present invention. The woven reinforcement material 10 comprises an elongated body 12 formed from a weave of warp strands and weft strands. Warp strands run lengthwise throughout a woven fabric. Weft strands run perpendicular to warp strands across the machine direction of the fabric. As illustrated the elongated body 12 has a first end section 14, a second end section 16 and an intermediate section 18.

The intermediate section 18 has a first thickness A while the first and second end sections 14, 16 have a second thickness B where A>B. More specifically, the first and second end sections 14, 16 and the intermediate section 18 include the same number of warp strands, M. However, the intermediate section 18 includes N weft strands and the first and second end sections include less than N weft strands. Typically the first and second end sections include N/2 to N/4 weft strands. By utilizing fewer weft strands in the end sections 14, 16, the thickness of the end sections is reduced. Preferably the end sections have a thickness B equal to one half the thickness A of the intermediate section. Accordingly, when end sections 14, 16 of adjacent, aligned sheets of woven reinforcement material 10 are spliced together, the thickness of the material at the spliced ends or joint is substantially equal to the thickness of the material along the intermediate sections 18 so that a constant thickness is maintained at all times.

In accordance with another aspect of the present invention, the first and second end sections 14, 16 have a length of between about 0.1 and about 1.0 meters. Further, each of the end sections 14, 16 has a surface area of between about 100,000 and about 4,000,000 square mm. Thus, when cooperating ends of two adjacent segments of woven reinforcement material 10 are spliced together the spliced joint has a surface area of between about 100,000 and about 4,000,000 square mm. Thus, process and end use loads are transferred over a greater area of work thereby relieving stresses that might otherwise weaken or break the spliced joint.

The elongated body 12 of woven reinforcement material 10 may be constructed from strands of reinforcing material selected from a group consisting of glass fibers, carbon fibers, aramid fibers, graphite fibers, ceramic fibers, mineral fibers, metal fibers, thermoplastic polymer fibers and mixtures thereof. Typically the individual fibers have a diameter of between about 9.0 to about 27.0 microns and a length of at least 25 mm. For certain applications the fibers utilized are continuous fibers. Further, the fibers typically have between about 200 to about 20,000 tex bundle.

The weave of the woven reinforcement material 10 may take the form of substantially any weave known in the art. A typical weave utilized is selected from a group consisting of plain, twill, satin, knit uniaxial, knit biaxial, knit triaxial, knit quadaxial and combinations thereof with mats.

In accordance with another important aspect of the present invention, the woven reinforcement material 10 incorporates taping in order to allow the end of the woven reinforcement material to be secured to a core around which the woven reinforcement material 10 is wound. Typically, the core is constructed from a tubular cardboard and is cylindrical in shape. During continuous processing it is important that the woven reinforcement material 10 release from the core without pulling cardboard from the core. In certain applications it is also desirable for the woven reinforcement material 10 to release from the core without including any tape.

In accordance with one approach illustrated in FIGS. 2 and 3, a first adhesive tape 20 is adhered to the first section 14 along a first end margin 22. In the illustrated embodiment, the first adhesive tape 20 extends fully across the first end margin 22. A first fastening tape 24 is provided at a first end of the first adhesive tape 20 adjacent a first lateral margin of the elongated body 12. Similarly, a second fastening tape 26 is provided at a second end of the first adhesive tape 20 adjacent a second lateral margin of the elongated body 12.

As illustrated, the first fastening tape 24 extends beyond the first lateral margin of the elongated body 12. Similarly, the second fastening tape 26 extends beyond the second lateral margin of the elongated body 12. As also illustrated, a third fastening tape 28 is connected to the first adhesive tape 20 along an intermediate portion thereof between the first and second fastening tapes 24, 26. This third fastening tape 28 extends beyond the first end margin 22 of the elongated body 12.

The elongated body 12 of the woven reinforcement material 10 is secured to the core 30 by first positioning the first end margin 22 of the elongated body 12 onto the face 32 of the core 30 (see FIG. 3). This is followed by the taping of the first corner of the first end margin 22 to the core 30. This is accomplished by extending the first fastening tape 24 over and around the first end 34 of the core 30. Adhesive provided on the lower face of the first fastening tape 24 securely adheres to the core 30 to complete the connection.

The method also includes the taping of the second corner of the first end margin 22 to the core 30. This is accomplished by extending the second fastening tape 26 over the second end 36 of the core 30. In addition, the method includes the step of taping an intermediate portion of the end margin 22 to the core 30 between the first and second corners. This is done by engaging the face 32 of the core 30 with the adhesive coated side or face of the third fastening tape 28.

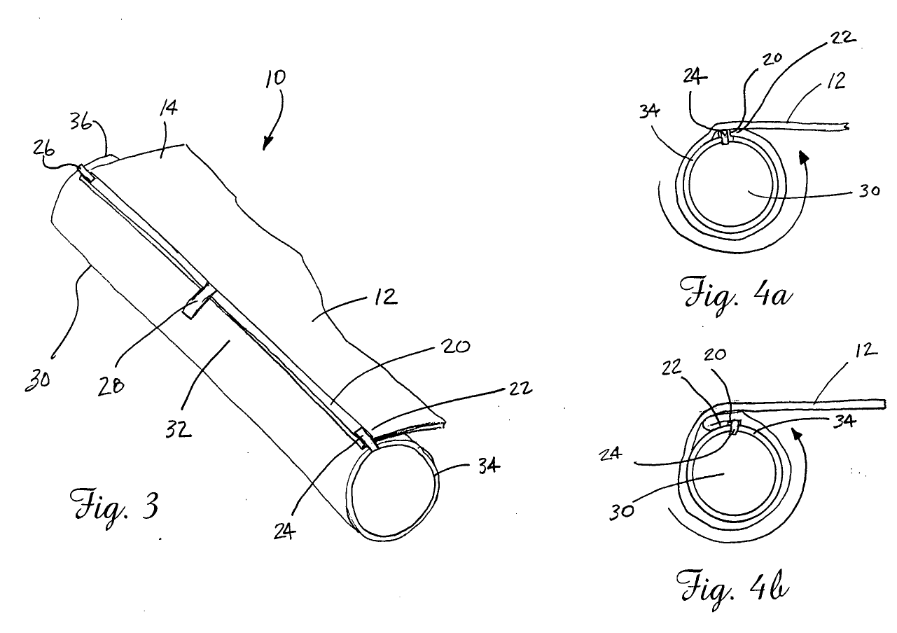

The method also includes the winding of the remainder of the elongated body 12 to the core 30 over the first adhesive tape 20. As illustrated in FIGS. 4a and 4b, this may be accomplished in one of two ways. As illustrated in FIG. 4, the core 30 may be rotated in a counterclockwise direction so as to wind the elongated body 12 of the woven reinforcement material 10 straight over the first adhesive tape 20 and the fastening tapes 24, 26 and 28. Alternatively, as illustrated in FIG. 4b, the elongated body 12 may be folded over the first end margin 22 and first adhesive tape 20 and then the remainder of the elongated body may be wound onto the core 30.

After winding, the second end section 16 may be taped down to the material 10 wound around the core 30 or the material 10 may be tied or bound to the core in some other way by string, elastic band or any other appropriate means. It should be appreciated that a second adhesive tape may be applied across the full width of the end margin of the second end section 16 in a manner similar to the first adhesive tape 20 and second end margin 22 as illustrated in FIG. 2. The end adhesive tapes 20 on the margins protect the material from fraying and serve to maintain a good clean edge.

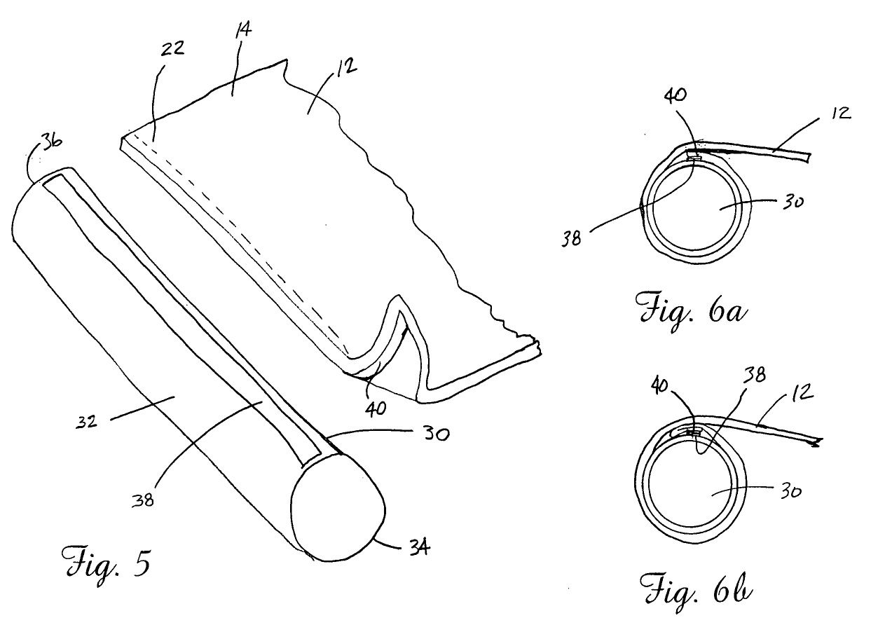

An alternative method of securing an elongated body 12 of woven reinforcement material 10 to a core 30 is illustrated in FIGS. 5, 6a and 6b. This method includes the step of attaching a strip of double-faced adhesive tape 38 to the face 32 of the core 30 from a first point adjacent a first end 34 of the core to a second point adjacent a second end 36 of the core. The method also includes the step of providing a strip of adhesive tape 40 over the first end margin 22 at the first end 14 of the elongated body 12. The adhesive tape 40 may extend all the way across the first end margin 22 from a first corner thereof to a second corner thereof. When it is desired to secure the woven reinforcement material 10 to the core 30, the adhesive tape 40 on the first end margin 22 is aligned with and secured to the double-faced adhesive tape 38 attached to the core 30. This is followed by the winding of the remainder of the elongated body 12 to the core 30.

As illustrated in FIG. 6a winding may be completed by simply rotating the core 30 and wrapping the remainder of the elongated body 12 straight over the first end margin 22 and the strip of double-faced adhesive tape 38. Alternatively, as illustrated in FIG. 6b, the elongated body 12 may first be folded over and then wound over the first end margin 22 and strip 38 of double-faced adhesive tape. After being fully wound onto the core, the second end section may be secured to the core by taping, banding or any other appropriate means. As previously noted, the end margin of the second end section may be taped if desired in order to protect that margin and edge against fraying.

No matter which taping procedure is utilized, the tape 20, 24, 26, 28, 38 or 40 may be constructed from a material selected from a group consisting of paper, polyester film, vinyl film, polyvinyl chloride film and mixtures thereof. The adhesive provided on one or both faces of the tapes 20, 24, 26, 28, 38 or 40 may be of any appropriate material such as an acrylic based resin. The tape material and adhesive is carefully selected to insure that the end margin 22 releases cleanly from the tape without fraying. For certain applications the tape material and tape adhesive is carefully selected to insure that the tape releases cleanly from the margin 22 of the elongated body 12 while remaining adhered to the core so that no tape is pulled into the spliced joint. For other applications, the margin tape 20, 40 is designed to remain secured to the end margin 22 of the elongated body 12. For these applications it is important that the tape releases cleanly from the cardboard of the core so that it does not pull cardboard into the spliced joint.

The foregoing description of the preferred embodiments of the invention have been presented for purposes of illustration and description. It is not intended to be exhaustive or to limit the invention to the precise form disclosed. Obvious modifications or variations are possible in light of the above teachings.

The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiment do not and are not intended to limit the ordinary meaning of the claims and their fair and broad interpretation in any way.

What is claimed is:

1. A woven reinforcement material, comprising:
an elongated body formed from a weave of warp strands and weft strands, said elongated body having a first end section, a second end section and an intermediate section, said intermediate section having a first thickness A and said first and second end sections having a second thickness B where A>B.

2. The material of claim 1, wherein said intermediate section includes N weft strands and said first and second end sections include less than N weft strands.

3. The material of claim 2, wherein said intermediate section, said first end section and said second end section all include M warp strands.

4. The material of claim 3, wherein said first and second end sections include N/2 to N/4 weft strands.

5. The material of claim 1, wherein said elongated body is constructed from a reinforcing material selected from a group consisting of glass fibers, carbon fibers, aramid fibers, graphite fibers, ceramic fibers, mineral fibers, metal fibers, thermoplastic polymer fibers and mixtures thereof.

6. The material of claim 5, wherein said fibers are continuous fibers.

7. The material of claim 5, wherein said fibers have between about 200 to about 20,000 tex bundle.

8. The material of claim 1, wherein said first end section includes a first end margin and said second end section includes a second end margin.

9. The material of claim 8, wherein a first adhesive tape is adhered to said first end margin.

10. The material of claim 9, wherein a second adhesive tape is adhered to said second end margin.

11. The material of claim 9, wherein a first fastening tape is provided at a first end of said first tape adjacent a first lateral margin of said elongated body and a second fastening tape is provided at a second end of said first tape adjacent a second lateral margin of said elongated body.

12. The material of claim 11, wherein said first fastening tape extends beyond said first lateral margin of said elongated body and said second fastening tape extends beyond said second lateral margin of said elongated body.

13. The material of claim 12, further including a third fastening tape connected to said first tape between said first and second fastening tapes and extending beyond said first end margin of said elongated body.

14. A method of securing an elongated body of a woven reinforcement material to a core having a first end, a face and a second end, comprising:
positioning a first end margin of said elongated body onto said face of said core;
taping a first corner of said first end margin of said elongated body to said core; and
taping a second corner of said first end margin of said elongated body to said core so that less than an entire width of said first end margin is taped to said core.

15. The method of claim 14, further including taping an intermediate portion of said end margin to said core between said first and second corners.

16. The method of claim 14, wherein said taping of said first corner includes extending a first strip of tape from said first corner over said first end of said core.

17. The method of claim 16, wherein said taping of said second corner includes extending a second strip of tape from said second corner over said second end of said core.

18. The method of claim 17, wherein said taping of said intermediate portion includes extending a third strip of tape over said intermediate portion and said face of said core.

19. The method of claim 18, further including providing a line of tape over said first end margin of said elongated body from said first corner to said second corner before taping said first corner, said second corner and said intermediate portion to said core.

20. The method of claim 19, further including winding a remainder of said elongated body to said core over said line of tape.

21. A method of securing an elongated body of a woven reinforcement material to a core having a first end, a second end and a face, comprising:
attaching a strip of double-faced adhesive tape to said face of said core from a first point adjacent a first end of said core to a second point adjacent a second end of said core;
providing a strip of tape over a first end margin of said elongated body from a first corner thereof to a second corner thereof; and
securing said strip of tape on said first end margin of said elongated body to said strip of double-faced adhesive tape attached to said core.
